(19) United States
(12) Patent Application Publication
(10) Pub. No.: US 2005/0071546 A1
(43) Pub. Date: Mar. 31, 2005

(54) Systems and methods for improving flexibility in scaling of a storage system

(76) Inventors: William P. Delaney, Wichita, KS (US); Russell J. Henry, Wichita, KS (US); Michael Nielson, Broomfield, CO (US); Bret S. Weber, Wichita, KS (US); Mohamad El-Batal, Westminster, CO (US); Walter A. Hubis, Louisville, CO (US)

Correspondence Address: LSI LOGIC CORPORATION, 1621 BARBER LANE, MS: D-106, MILPITAS, CA, 95035, US

(21) Appl. No.: 10/671,158

(22) Filed: Sep. 25, 2003

(51) Int. Cl. G06F 12/00

(52) U.S. Cl. 711/112

(57) ABSTRACT

Apparatus and methods are provided for improving scalability of a storage system. In one embodiment, a storage system comprising a stand-alone storage element that is reconfigurable to improve storage performance features of the storage system. The storage element comprises a plurality of disk drives, each configured for storing data. The storage element also comprises a storage controller communicatively adapted for coupling to a host computer system and configured for processing I/O requests received from the host computer system. The storage controller is also adaptable to interface with another storage controller added to the storage system. When adapted to communicate with the other storage controller, the storage controller of the stand-alone storage element can route the I/O requests to the other storage controller through a switching fabric.

### RELATED PATENTS

This patent application is related to co-pending, commonly owned U.S. patent application Ser. No. 10/329,184 (filed Dec. 23, 2002; the “'184 application”) and U.S. patent application Ser. No. 10/328,672 (filed Dec. 23, 2002; the “'672 application”), which are hereby incorporated by reference. Additionally, U.S. Pat. No. 6,173,374 (issued Jan. 9, 2001; the “'374 patent”) and U.S. Pat. No. 6,073,218 (issued Jun. 6, 2000; the “'218 patent”) provide useful background information and are hereby incorporated by reference.

### BACKGROUND OF THE INVENTION

1. Field of the Invention

This invention generally relates to scaling of a storage system. More specifically a modular architecture allows a storage system to be easily scaled from a stand alone storage system to an expanded system coupling a plurality of storage systems in a storage network architecture.

2. Discussion of the Related Art

A mass storage system is used for storing user and system data in data processing applications. A typical mass storage system includes a plurality of computer disk drives configured for cooperatively storing data as a single logically contiguous storage space often referred to as a volume or logical unit. One or more such volumes or logical units may be configured in a storage system. The storage system, therefore, performs much like that of a single computer disk drive when viewed by a host computer system. For example, the host computer system can access data of the storage system much like it would access data of a single internal disk drive, in essence, oblivious to the substantially transparent underlying control of the storage system.

Mass storage systems may employ Redundant Array of Independent Disks (“RAID”) management techniques, such as those described in “A Case For Redundant Arrays Of Inexpensive Disks”, David A. Patterson et al., 1987 (“Patterson”). RAID levels exist in a variety of standard geometries, many of which are defined by Patterson. For example, the simplest array, a RAID level 1 system, comprises one or more disks for storing data and an equal number of additional “mirror” disks for storing copies of the information written to the data disks. Other RAID management techniques, such as those used in RAID level 2, 3, 4, 5 and 6 systems, segment or stripe the data into portions for storage across several data disks, with one or more additional disks utilized to store error check or parity information.

Regardless of storage management techniques, a mass storage system may include one or more storage elements with each individual storage element comprising a plurality of disk drives coupled to one or more control elements. In one typical configuration, a storage element may be coupled through its control element(s) directly to a host system as a stand-alone storage element. Such direct coupling to a host system may utilize any of numerous communication media and protocols. Parallel SCSI buses are common for such direct coupling of a storage system to a host. Fibre Channel and other high speed serial communication media are also common in high performance environments where the enterprise may require greater physical distance for coupling between the storage systems and the host systems.

In another standard configuration, the storage element may be part of a larger storage network. In a storage network architecture, a plurality of storage elements is typically coupled through a switched network communication medium (i.e., a fabric) to one or more host systems. This form of a multiple storage element system is often referred to as a Storage Area Network (“SAN”) architecture and the switching fabric is, therefore, often referred to as an SAN switching fabric. Such a switching fabric may, for example, include Fibre Channel (FC), Small Computer System Interface (SCSI), Internet SCSI (ISCSI), Ethernet, Infiniband, SCSI over Infiniband (e.g., SCSI Remote Direct Memory Access Protocol or SRP), piping, and/or various other physical connections and protocols. Standards and specifications of these and other switch fabric communication media and protocols are readily available to those skilled in the art from various sources.

The differences between a stand-alone storage system and a storage network architecture are marked. In a stand-alone storage element system, a host computer system will directly send Input/Output (“I/O”) requests to the storage controller(s) of the storage element. The storage element controller receiving the request, in general, completely processes the received I/O requests to access data stored within the disk drives of the storage element. The storage controller then identifies and accesses physical storage spaces by identifying and accessing particular LUNs within one or more of the disk drives of the storage element. Via the storage controller, the host computer system can then read data from the storage spaces or write data to the physical storage spaces.

By way of contrast, in a multiple storage element configuration (i.e., networked storage), the various LUNs or even a single LUN can be spread across one or more storage elements of the storage system. In such a multiple element storage system the switching fabric may be used to effectuate communication between the control elements of one or more storage elements as well as between the control elements and the host systems. A host computer may communicate an I/O request to the storage system and, unbeknownst to the host system, the I/O request may be directed through the switching fabric to any control element of any of the storage elements. The control elements of multiple storage elements may require communications to coordinate and share information regarding LUNs that are distributed over multiple storage elements. Information returned by the control elements is routed back through the switched fabric to the requesting host system.

For any of several reasons, an enterprise may wish to change from a direct coupled storage element to a storage network architecture for coupling storage elements to host systems. For example, a network architecture may allow for increased available communication bandwidth where multiple host communication links may be available between the networked complex of storage elements and one or more host systems. Another potential benefit of a network storage architecture derives from the increased storage performance realized by the cooperative processing of multiple storage controllers that are interconnected to share the workload of requested I/O operations. Another possible reason for an enterprise to convert to a storage network architecture is to increase storage capacity beyond the capacity of a single, stand-alone storage element. The above-mentioned benefits and reasons may hereinafter be collectively referred to as storage performance features.

Any particular storage element has a finite storage capacity because, for example, a storage element has a finite physical area in which the disk drives may be placed. In addition, performance of the storage element may be limited to a number of possible controllers that may be configured within a stand-alone storage element for processing of host system I/O requests. Alternatively, a storage element may have a limit on the number of direct host communication links and hence a limit on the available bandwidth for communicating between the storage subsystem and host systems. Accordingly, when an organization requires improved performance features from its storage system, the organization may implement a new storage system designed with multiple storage elements in a storage network architecture to provide additional storage capacity and/or performance to overcome the limitations of a single stand-alone storage element.

Since a stand-alone storage element has a controller configured for direct access by a host computer system but typically not for cooperation and coordination with other controllers of other storage elements, implementation of a new multiple storage element networked storage system may include replacement of the storage controller(s) of the stand-alone storage element(s). Different storage controllers may be required to provide the required interconnection between storage controllers of the multiple storage elements to permit desired cooperation and coordination between the multiple storage elements. Such a reconfiguration of the stand-alone storage element is necessary because the storage element may coordinate with other storage elements through an SAN switching fabric not previously required in a stand-alone storage element.

Upgrades to an existing stand-alone storage system to enable networked communications among multiple storage elements remain an expensive process. In addition to possible replacement of storage controllers, retrofitting a present stand-alone storage element to operate as one of a plurality of storage elements in a networked storage system typically requires other components to implement communication between the storage controllers. Costly, complex N-way fabric switches add significant cost for the initial conversion from a stand-alone configuration to a storage network configuration.

Although storage performance feature requirements often grow in an enterprise, the cost for conversion to a networked storage architecture may be prohibitive to smaller enterprises. It is therefore evident that a need exists to provide improved methods and structure for improving storage performance feature scalability to permit cost effective growth of storage as an organization grows.

### SUMMARY OF THE INVENTION

The present invention solves the above and other problems, thereby advancing the state of the useful arts, by providing reconfigurable functionality in a storage element allowing for simpler upgrade of stand-alone operation of storage elements for use in a network architecture storage system. The storage controller of a storage element may be communicatively coupled directly to a host computer system and configured for processing I/O requests received from the host computer system. Additionally, the storage controller is adaptable to interface with a second storage controller using SAN fabric communication structures and protocols. For example, the storage controller is adaptable to communicate with the second storage controller and to route I/O requests to the second storage controller through a switching fabric. Accordingly, the storage controller may include “on-board” functionality to communicatively couple the storage element to a host computer system and to the switching fabric. In one embodiment, such functionality is implemented through a plug-in card (“PIC”) connected to the storage controller that configurably allows either stand-alone operation or networked operations with connectivity among a plurality of storage controllers.

In one embodiment, a storage system comprises a first storage element. The first storage element comprises: a plurality of disk drives, each configured for storing data; and a first storage controller communicatively coupled to a host computer system and configured for processing I/O requests received from the host computer system. The first storage controller is adaptable to interface with a second storage controller added to the storage system within a second storage element. The first storage controller is further adaptable, when adapted to communicate with the second storage controller, to route the I/O requests to the second storage controller through a switching fabric.

In another embodiment, the storage system is a RAID storage system.

In another embodiment, the switching fabric is an SAN switching fabric communicatively coupled to the first and the second storage controllers and configured for routing the I/O requests between the host computer system and the first and the second storage controllers and comprising at least one of Fibre Channel and Infiniband.

In another embodiment, the storage system is adaptable to identify physical storage locations of both the first and the second storage elements using an I/O module added to the storage system when the first storage controller is adapted to communicate with the second storage controller.

In another embodiment, the first storage controller comprises an N-chip configured for communicatively coupling to the SAN switching fabric to route a portion of the I/O requests from the host computer system through the SAN switching fabric to the second storage controller, wherein the N-chip is further configured for accessing data from the physical storage locations of both the first and the second storage elements to the I/O module.

In one embodiment, a method of processing requests from a host computer system comprises: transferring the requests from the host computer system to a first storage controller of a first storage element; and processing the requests to access physical storage locations within the first storage element. Transferring comprises forwarding a first portion of the requests from the first storage controller to a second storage controller of a second storage element.

In another embodiment, the method further comprises processing the first portion of the requests with the second storage controller to access physical storage locations within the second storage element.

In another embodiment, the method further comprising directly mapping a second portion of the requests to the physical storage locations within the first storage element and directly mapping a third portion of the requests to the physical storage locations of the second storage element.

In another embodiment, mapping comprises translating virtual storage addresses into physical addresses to access the physical storage locations of the first and the second storage elements.

In another embodiment, transferring the first portion of the requests comprises switching the first portion of the requests through an SAN switching fabric selected from at least one of Fibre Channel and Infiniband.

In one embodiment, a first storage controller comprises: a host interface configured for communicatively coupling a host computer system to a first storage element; a storage system interface configured for communicatively coupling the first storage element to a switching fabric; and a processor configured for processing I/O requests received through the storage system interface and the host interface to access physical storage locations. The storage system interface is further configured for transferring a portion of the I/O requests through the switching fabric to a second storage controller.

In another embodiment, the first storage controller is adapted to route the portion of the I/O requests to a second storage element and wherein the portion of the requests are processed by the second storage controller for accessing physical storage locations within the second storage element.

In another embodiment, the first storage controller further comprises a disk drive interface configured for communicatively coupling to a plurality of disk drives of the first storage element to access physical storage locations of the first storage element.

In another embodiment, the storage controller is a RAID storage controller.

In another embodiment, the storage controller further comprises computer memory configured for storing software instructions, wherein the software instructions direct the processor to transfer the portion of the I/O requests through the switching fabric to the second storage controller of a second storage element.

In one embodiment, a method of storing data comprises: configuring a first storage element with a first storage controller capable of interfacing with a host computer system and a switching fabric; and at least one of transferring I/O requests from the host computer system to the first storage controller to access a plurality of physical storage locations within the first storage element and transferring I/O requests from the host computer system through the switching fabric to a second storage controller configured with a second storage element.

In another embodiment, transferring I/O requests from the host computer system through the switching fabric to the second storage controller comprises processing the I/O requests with the second storage controller to access physical storage locations within the second storage element.

In another embodiment, the method further comprises directly mapping a first portion of the I/O requests transferred to the first storage controller to the physical storage locations within the fist storage element and directly mapping a second portion of the I/O requests to the physical storage locations of the second storage element.

In another embodiment, mapping comprises translating virtual storage addresses into physical addresses to access the physical storage locations of the first and the second storage elements.

In another embodiment, transferring the I/O requests comprises switching the I/O requests through an SAN switching fabric selected from at least one of Fibre Channel and Infiniband.

### BRIEF DESCRIPTION OF THE DRAWINGS

FIG. 1 is a block diagram of a storage system in one embodiment of the invention.

FIG. 2 is a block diagram of a storage controller in one embodiment of the invention.

FIG. 3 is another block diagram of a storage system in one embodiment of the invention.

FIG. 4 illustrates a methodical operation of a storage system in one embodiment of the invention.

### DETAILED DESCRIPTION OF THE DRAWINGS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents and alternatives falling within the spirit and scope of the invention as defined by the appended claims.

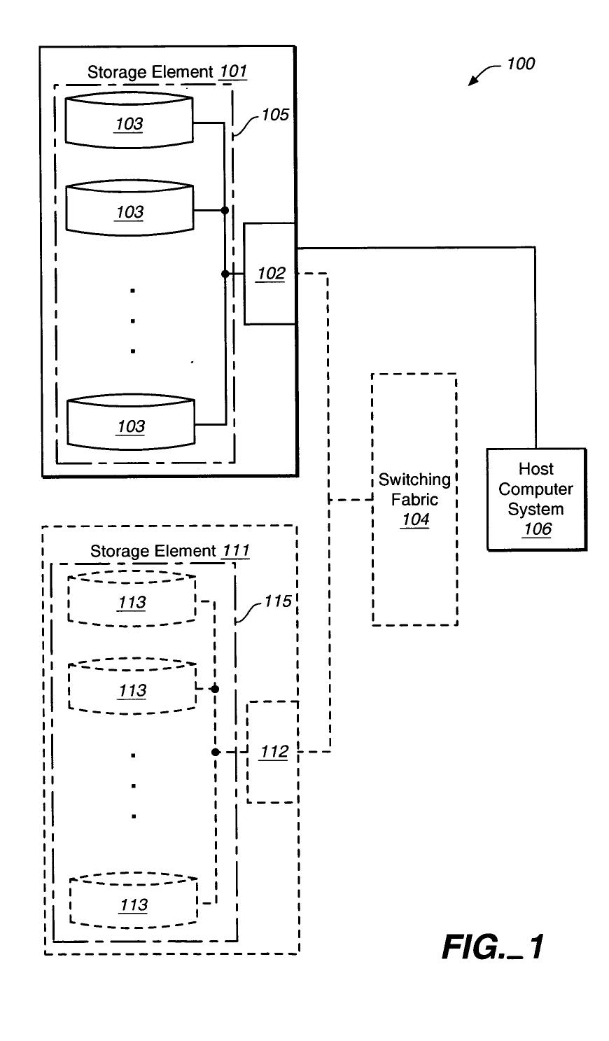

With reference now to the figures and in particular with reference to FIG. 1, an embodiment hereof is shown in storage system 100. System 100 includes a storage element 101 comprising a plurality of disk drives 103. The disk drives 103 may be computer disk drives as typically found in a computer; however, other storage devices, such as data storage tapes may be used as well. Such a configuration of multiple disk drives is sometimes packaged as “Just a Box Of Disks” (JBOD 105). Regardless of the packaging, each disk drive 103 is configured for storing data for storage system 100. Storage element 101 also includes a storage controller 102 communicatively coupled to host computer system 106. Storage controller 102 is configured for processing I/O requests received from host computer system 106.

As noted above, storage performance features of an enterprise may grow over time such that an additional storage element 111 may be required. Addition of storage element 111 may provide, for example, additional storage capacity, additional processing capacity to process I/O requests and/or additional host system communication bandwidth.

In one embodiment hereof, storage controller 102 is adaptable to further interface with storage controller 112 of added storage element 111. Accordingly, storage controller 102 may communicate with the storage controller 112 to route I/O requests through switching fabric 104. For example, when storage element 111 is added to storage system 100, some of the I/O requests will be directed to storage element 111. When an I/O request intended for storage element 111 is received by storage element 101, storage controller 102 may route the request through switching fabric 104 to storage controller 112 for processing. Such a transfer may occur when the data to be accessed by host computer system 106 is stored on one or more disk drives 113 of JBOD 115. When data requested by host system 106 (e.g., via an I/O request) resides in portions of both storage elements 101 and 111, storage controller 102 may process the portion of the request relevant to storage element 101 and transfer the remaining portion that is relevant to storage element 111 onto storage controller 112 through fabric 104.

In this embodiment, storage element 111, its associated components and switching fabric 104 are drawn with dotted lines to illustrate that these components of storage system 100 are added to the existing storage element 101. Therefore, storage element 101 may operate as a stand-alone storage element within storage system 100 until an improved configuration is desired. For example, when more storage capacity is required, one or more of storage elements 111 may be added to storage system 100. When processing performance increases are desired, an added storage element 111 may include multiple storage controllers 112 to cooperatively process I/O requests with storage controller 102. The addition of storage controller 112 may also serve to increase host system communication bandwidth by the addition of more host connection ports in controller 112 (not shown). Functionality to flexibly configure storage system 100 with added storage elements may reside in storage controller 102 as resident functionality or as a PIC configured for communicatively coupling to storage controller 102 to implement such functionality.

While discussed with respect to routing requests from storage controller 102 through switching fabric 104 to storage controller 112, those skilled in the art should readily recognize that storage controller 112 may also route requests through switching fabric 104 to storage controller 102. Accordingly, storage controller 112 may possess similar functionality found in storage controller 102. Additionally, while this embodiment illustrates two storage elements, the invention is not intended to be limited to the particular number of depicted storage elements, storage controllers, and/or disk drives of the embodiment. Nor is the embodiment intended to be limited to the particular number of depicted switching fabrics and host computer systems. Rather, a plurality of host computer systems may be communicatively coupled to a plurality of storage elements through a plurality of switching fabrics. Accordingly, the embodiment presented is merely exemplary in nature and intended to show the functionality of storage controller 102 accommodating flexible configuration for improving storage performance features.

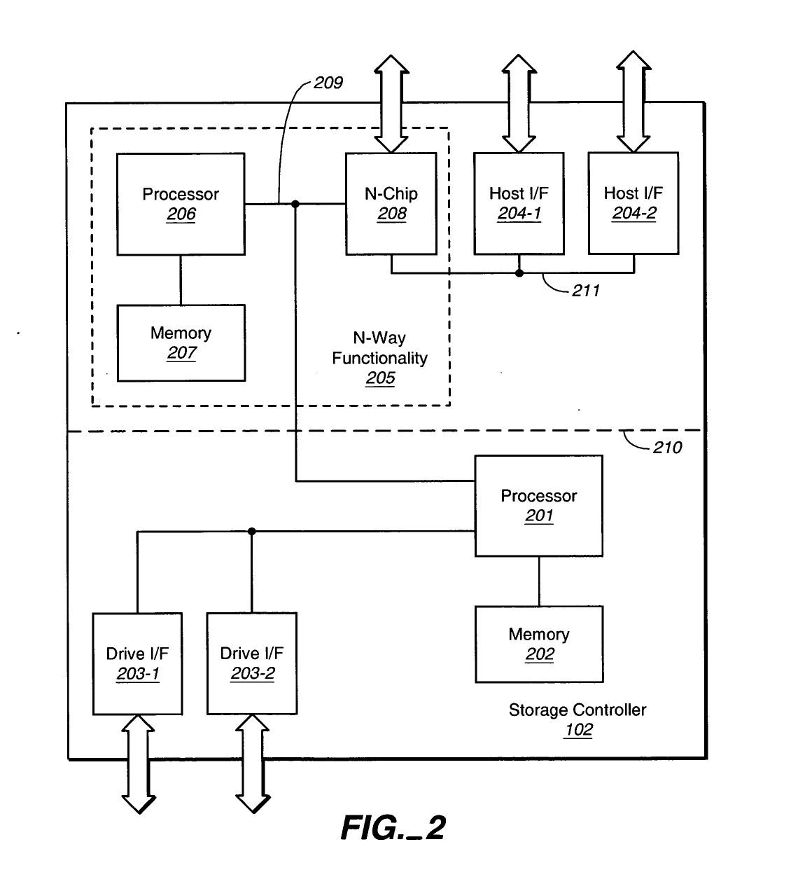

FIG. 2 is a block diagram providing additional detail of an exemplary embodiment of storage controller 102 of FIG. 1. Storage controller 102 is configured for controlling access to data located within a plurality of disk drives, such as disk drives 103 of FIG. 1. Storage controller 102 may be configured within a storage element, such as storage element 101 of FIG. 1, to control access to data by a host computer system, such as host computer system 106 of FIG. 1. For example, the host computer system may transfer I/O requests to storage controller 102 wherein storage controller 102 processes the requests and either reads data from the disk drives or writes data to the disk drives based on the request.

Accordingly, in this embodiment, storage controller 102 comprises host interfaces 204-1 and 204-2 configured for receiving the I/O requests from the host computer system. This host interface functionality allows a host computer system to communicate directly with the storage element. Storage controller 102 also comprises N-chip 208 coupled to the host interfaces 204-1 and 204-2 through bus 211. N-chip 208 is configured for receiving I/O requests from one or more host computer systems and routing such requests to other storage controllers of the storage system. For example, when a storage element is added to the storage system to upgrade the storage capacity of the storage system, N-chip 208 communicates to the added storage element through a switching fabric such as a SAN switching fabric. N-chip 208 therefore represents any device used to couple the controller to a SAN fabric (i.e., fabric 104 of FIG. 1). The N-chip may provide N-way connectivity among the plurality of controllers coupled to the fabric (i.e., controllers 102 and 112 of FIG. 1). Such a device may be a commercially available component such as, for example, a Fibre Channel interface device or may be a custom device such as an application specific integrated circuit (“ASIC”) or full custom integrated circuit. An exemplary embodiment of an N-chip is discussed in the '184 patent incorporated herein.

The N-chip 208 is further coupled to processor 206 to perform initial processing on a received I/O request sufficient to forward the request to another storage element. Processor 206 may be coupled to memory 207 to provide local program instruction and variable storage. Processor 206 may determine the proper storage element to process a received I/O request. Mapping information identifying logical units (volumes) on each storage element may be shared among all controllers 102 in a network storage architecture. Processor 206 may store such mapping information in memory 207 and utilize the information to determine which storage element should process the I/O request.

For example, the host computer system may transfer an I/O request through a host interface 204-1 or 204-2 via bus 211 to N-chip 208, which in turn transfers the request to processor 206 via bus 209. Processor 206 may then utilize the stored mapping information to determine a physical storage location of the data requested by the host computer system. Once the proper storage element is determined, processor 206 may forward the I/O request to the controller of the proper storage element. If the requested data is on a different storage element, processor 206 forwards the request to N-chip 208 via bus 209 for routing of the request to an actual physical storage location of the data within another storage element (i.e., via an associated storage controller of the other storage element). The N-chip 208 directs the request to another controller of another storage element via the SAN fabric coupled to the N-chip 208. If the data is physically located within the storage element in which storage controller 102 is configured, processor 206 transfers the request via bus 209 to processor 201 for accessing the physical storage locations through one or more of drive interfaces 203-1 and 203-2.

As previously described, storage controller 102 may operate in a stand-alone mode where the storage controller interfaces directly and exclusively with a host computer system via host interfaces 204-1 and 204-2. Controller 102 may therefore receive requests directly from a host system. Storage controller 102 may also operate in an N-way mode to the extent that storage controller 102 routes requests among other storage controllers within the storage system. N-chip 208 may therefore receive I/O requests from other storage controllers configured within the storage system and process the I/O requests.

If an I/O request is intended to access data of the storage element in which the storage controller 102 is configured, regardless of the source of the I/O request, the N-chip 208 may transfer the request to processor 201 for processing of the request. Accordingly, processor 201 may be configured for processing I/O requests directed to the storage element in which storage controller 102 is configured. Memory 202 may be communicatively coupled to processor 201 for storing instructions that direct processor 201 to access actual physical storage locations of the storage element through one or both of drive interfaces 203-1 and 203-2. Data is then either retrieved from the physical storage locations or written to the physical storage locations based on the I/O request and as directed by processor 201.

Processor 206, memory 207 and N-chip 208 form N-way functionality 205 for storage controller 102. In one embodiment, N-way functionality 205 and stand-alone functionality of host interfaces 204-1 and 20402 is configured as a PIC that interfaces to storage controller 102 indicated by dotted line 210. For example, storage controller 102 may be configured to connect to a PIC having either of or both of N-way functionality 205 and stand-alone functionality. Such an embodiment may accommodate flexible reconfiguration of storage controller 102 and improved storage performance features. In a solely stand-alone embodiment, host interfaces 204-1 and 204-2 may connect directly to processor 201 via a bus connection bypassing the N-chip 208 connectivity. In other embodiments, N-way functionality 205 may be populated on the PIC but host interfacing 204-1 and 204-2 may be removed. In an embodiment where both N-way functionality 205 and host connectivity through interfaces 204-1 and 204-2 are included, an appropriately populated PIC may be used.

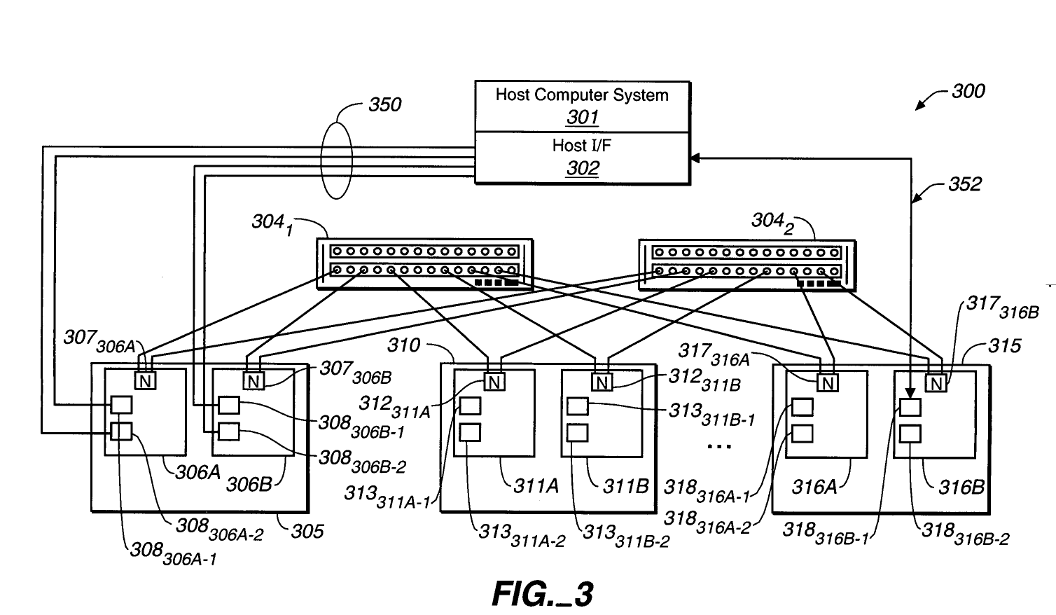

FIG. 3 is a block diagram of a storage system 300 embodying features and aspects hereof. As shown in this embodiment, storage system 300 is coupled to a host system 301 through the host system's interface 302. As noted above, such a host interface 302 coupled to the storage subsystem 300 may utilize parallel SCSI, Fibre Channel and/or other well known industry standard media and protocols. Storage system 300 includes a storage element 305 comprising storage controllers 306A and 306B. Storage element 305 is depicted as having been a stand-alone storage element configured for direct communication with host system 301. Specifically, storage controllers 306A and 306B of storage element 305 are communicatively coupled to host interface 302 of host computer system 301 via host interface connections (i.e., 308_{306A-1}, 308_{306A-2} and 308_{306B-1}, 308_{306B-1}, respectively) and associated communication paths 350. The storage controllers 306A and 306B may operate as a redundant pair of RAID storage controllers, as generally known in the art.

Storage system 300 as depicted has been reconfigured to improve storage performance features by adding storage elements 310 and 315 and reconfiguring operation of the storage elements to act in accordance with a networked storage architecture. In particular, storage element 305 may be reconfigured by altering functionality of the storage controllers 306A and 306B. For example, a PIC such as that described in FIG. 2 coupled to each of storage controllers 306A and 306B may incorporate N-way functionality such that storage controllers 306A and 306B cooperate and coordinate with controllers 311A, 311B and 316A, 316B of storage elements 310 and 315, respectively. N-way functionality may be integrated onto the PIC via an N-chip, such as N-chip 307_{306A} of storage controller 306A. Using the N-chip of the controller and switched fabric 304₁ and 304₂, storage element 305 may communicate to other storage elements 310 and 315. Controllers 311A and 311B of storage element 310 and controllers 316A and 316B of storage element 315 similarly include N-chip components. For example, controllers 311A and 311B each include an N-chip 312_{311A} and 312_{311B} and controllers 316A and 316B each include N-chip 317_{316A} and 317_{316B} for coupling the corresponding controller to the fabric 304₁ and/or 304₂. N-chips 307_{306A} and 307_{306B} of storage controllers 306A and 306B, respectively, may interconnect with switching fabric 304₁ and 304₂ to communicatively connect to any of storage elements 310 and 315 via storage controllers (i.e. via the N-chips of those storage controllers) associated with storage elements 310 and 315.

Through the fabric connection of the various storage elements, the storage controllers may cooperate and coordinate the processing of I/O requests received from the host system. The addition of storage elements 310 and 315 therefore enhance the performance features of the storage system 300 by increasing storage capacity and increasing available processing capability for I/O requests. Further, added storage elements may include additional host connections to enhance the available communication bandwidth between the storage system and the host systems. For example, storage element 315 is shown as including an additional communication path between host 301 and host interface chip 318_{316B-1} of controller 316B.

With N-way functionality and host interface connect functionality incorporated within each of the storage controllers of storage elements 305, 310 and 315, host computer system 301 may direct I/O requests to any of storage elements 305, 310 and 315 through its host interface connections and the storage system 300 will transparently process the request in one or more appropriate storage elements. Those skilled in the art will readily recognize that the invention is not intended to be limited to the number of switching fabrics, storage elements, host computer systems, host interfaces, storage controllers and/or N-chips of the exemplary embodiment.

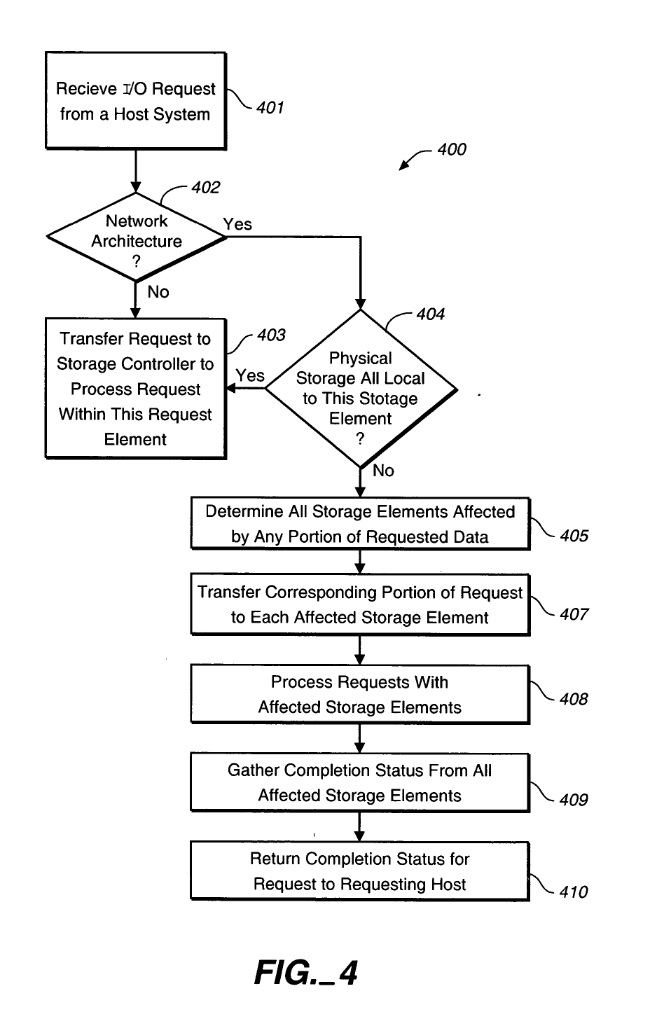

FIG. 4 illustrates a methodical operation of features and aspects hereof in a storage system. A host computer system transfers an I/O request to a storage element to access physical storage locations of the storage element. In element 401, the storage element receives-the request. Element 402 determines whether other storage elements exist within the present storage system. In other words, element 402 determines whether the storage element receiving the request is a stand-alone storage element or part of a network storage architecture subsystem. If the storage element is a stand-alone storage element, element 403 is next operable to process the I/O request according to normal processing aspects of the storage element. If the storage element receiving the request is part of a network storage architecture system, element 404 next determines whether all requested information is resident on the storage element receiving the host request. If so, element 403 is operable as above to process the I/O request normally within the receiving storage element. Otherwise, processing continues with element 405.

Element 405 determines all storage elements of the network storage subsystem that may be affected by the I/O request. For example, a storage controller, such as storage controller 102 of FIG. 2, may receive the request and determine which storage elements of the entire storage system are to be accessed by the request. As noted above, a single LUN or volume may be distributed over multiple storage elements of the subsystem. All storage elements affected by the data to be accessed by the I/O request are therefore identified by element 405. Element 407 then transfers the corresponding portion of the received I/O request to each of the identified affected storage elements. The I/O request may therefore be subdivided into multiple I/O request portions—one for each affected storage element. The multiple I/O request portions are transferred over the switched fabric to the storage controllers of the affected storage elements. If a portion of the I/O request is to be processed locally by the receiving storage element, the request may be transferred and accordingly processed within the storage element. For example, a processor of a storage controller may transfer the portion of the request to another processor within the storage control for internal processing of the portion of the request.

Element 408 then causes initiation of processing of the I/O request portions in each of the affected storage elements. Initiation of processing may merely entail completion of the transfer of the I/O request portion to each affected storage element or the initiation of processing may entail a coordination message indicating when processing should commence if such coordination should be required. Element 409 then awaits receipt of completion status information from the affected storage elements indicating completion of the corresponding I/O request portion. The receiving storage element that subdivided and distributed the request to affected storage elements gathers all completion information from the affected elements. For example, when a storage controller receives data from other storage elements within the storage system in response to a read request, the storage controller may aggregate the data so that it may return the data to the host system making the request. Accordingly, element 410 implements a return of aggregated completion status to the requesting host system as gathered from status reports of each affected storage elements.

Those of ordinary skill in the art will recognize that such processing may be conducted in parallel for multiple requests received from one or more host systems by one or more cooperating storage elements. Processing of element 409 awaiting completion of each of the affected storage elements will not require complete pause of all other operations. Rather, well known, event driven or interrupt driven techniques may be employed to permit continued processing of other I/O requests while a first request is in process. Well known coordination and interlock techniques and structures may be employed to assure that any requests that must be processed in a particular chronological order will be so processed.

Advantages of the embodiments described herein include the ability of a storage system having a stand-alone storage element to improve storage performance features through the addition of other storage elements or components thereof. Such an ability exists in a reconfigurable storage controller of the stand-alone storage element that allows the storage element to process I/O request locally and/or to transfer I/O requests from a host computer system to other cooperating storage elements through a switched fabric or other communication link. Reconfiguring a stand-alone storage element to permit cooperation with other storage elements in a network storage architecture permits an organization to reconfigure the storage system and improve storage performance features in a cost effective manner as the organization grows.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

1. A storage system comprising:
a first storage element, comprising
a plurality of disk drives, each configured for storing data; and
a first storage controller communicatively coupled to a host computer system and configured for processing I/O requests received from the host computer system,
wherein the first storage controller is adaptable to interface with a second storage controller added to the storage system within a second storage element, and
wherein the first storage controller is further adaptable, when adapted to communicate with the second storage controller, to route the I/O requests to the second storage controller through a switching fabric.

2. The storage system of claim 1, wherein the storage system is a RAID storage system.

3. The storage system of claim 1, wherein the switching fabric is an SAN switching fabric communicatively coupled to the first and the second storage controllers and configured for routing the I/O requests between the host computer system and the first and the second storage controllers and comprising at least one of Fibre Channel and Infiniband.

4. The system of claim 3, wherein the storage system is adaptable to identify physical storage locations of both the first and the second storage elements using an I/O module added to the storage system when the first storage controller is adapted to communicate with the second storage controller.

5. The storage system of claim 4, wherein the first storage controller comprises an N-chip configured for communicatively coupling to the SAN switching fabric to route a portion of the I/O requests from the host computer system through the SAN switching fabric to the second storage controller, wherein the N-chip is further configured for accessing data from the physical storage locations of both the first and the second storage elements to the I/O module.

6. A method of processing requests from a host computer system, comprising:
transferring the requests from the host computer system to a first storage controller of a first storage element; and
processing the requests to access physical storage locations within the first storage element,
wherein transferring comprises
forwarding a first portion of the requests from the first storage controller to a second storage controller of a second storage element.

7. The method of claim 6, further comprising processing the first portion of the requests with the second storage controller to access physical storage locations within the second storage element.

8. The method of claim 7, further comprising directly mapping a second portion of the requests to the physical storage locations within the first storage element and directly mapping a third portion of the requests to the physical storage locations of the second storage element.

9. The method of claim 8, wherein mapping comprises translating virtual storage addresses into physical addresses to access the physical storage locations of the first and the second storage elements.

10. The method of claim 6, wherein transferring the first portion of the requests comprises switching the first portion of the requests through an SAN switching fabric selected from at least one of Fibre Channel and Infiniband.

11. A first storage controller, comprising:
a host interface configured for communicatively coupling a host computer system to a first storage element;
a storage system interface configured for communicatively coupling the first storage element to a switching fabric; and
a processor configured for processing I/O requests received through the storage system interface and the host interface to access physical storage locations,
wherein the storage system interface is further configured for transferring a portion of the I/O requests through the switching fabric to a second storage controller.

12. The storage controller of claim 11, wherein the first storage controller is adapted to route the portion of the I/O requests to a second storage element and wherein the portion of the requests are processed by the second storage controller for accessing physical storage locations within the second storage element.

13. The storage controller of claim 11, further comprising a disk drive interface configured for communicatively coupling to a plurality of disk drives of the first storage element to access physical storage locations of the first storage element.

14. The storage controller of claim 11 is a RAID storage controller.

15. The storage controller of claim 11, further comprising computer memory configured for storing software instructions, wherein the software instructions direct the processor to transfer the portion of the I/O requests through the switching fabric to the second storage controller of a second storage element.

16. A method of storing data, comprising:
configuring a first storage element with a first storage controller capable of interfacing with a host computer system and a switching fabric; and
at least one of
transferring I/O requests from the host computer system to the first storage controller to access a plurality of physical storage locations within the first storage element and
transferring I/O requests from the host computer system through the switching fabric to a second storage controller configured with a second storage element.

17. The method of claim 16, wherein transferring I/O requests from the host computer system through the switching fabric to the second storage controller comprises processing the I/O requests with the second storage controller to access physical storage locations within the second storage element.

18. The method of claim 17, further comprising directly mapping a first portion of the I/O requests transferred to the first storage controller to the physical storage locations within the fist storage element and directly mapping a second portion of the I/O requests to the physical storage locations of the second storage element.

19. The method of claim 18, wherein mapping comprises translating virtual storage addresses into physical addresses to access the physical storage locations of the first and the second storage elements.

20. The method of claim 16, wherein transferring the I/O requests comprises switching the I/O requests through an SAN switching fabric selected from at least one of Fibre Channel and Infiniband.
